(19) United States
(12) Patent Application Publication
(10) Pub. No.: US 2007/0031054 A1
(43) Pub. Date: Feb. 8, 2007

(54) Encoding DCT coordinates

(75) Inventor: Joseph Shain, Tel Aviv (IL)

Correspondence Address: DEKEL PATENT LTD., DAVID KLEIN, BEIT HAROF'IM, 18 MENUHA VENAHALA STREET, ROOM 27, REHOVOT, 76209, IL

(73) Assignee: NeoMagic Israel Ltd.

(21) Appl. No.: 11/198,223

(22) Filed: Aug. 8, 2005

(51) Int. Cl. G06K 9/36

(52) U.S. Cl. 382/250; 382/246

(57) ABSTRACT

A method for encoding DCT (Discrete Cosine Transform) coordinates, the method including partitioning an image into blocks of size n×m, transforming the blocks with a DCT to obtain DCT coefficients, quantizing the DCT coefficients, and transmitting the DCT coefficients of the image as a series of (nm) streams, wherein each stream contains all of values representing a given coordinate within each of the blocks.

### FIELD OF THE INVENTION

The present invention relates generally to methods for improving compression efficiency in image coding schemes, such as but not limited to, run-length coding and variable length coding, and particularly to encoding DCT coordinates in an efficient manner, such as in a manner that may be processed by associative processing.

### BACKGROUND OF THE INVENTION

As is well known in the art, the Discrete Cosine Transform (DCT) has been used for the transformation in most of the coding standards, such as but not limited to, JPEG, H.261/H.263 and MPEG. For example, referring to FIG. 1, in JPEG, an image is typically partitioned into rectangular blocks of size 8×8 (step 101) and each block is transformed separately with a 2D-DCT (steps 102-105). The DCT coefficients are quantized and transmitted/stored in a progressive manner (steps 106-108), so that the most important information is transmitted first.

Specifically, each 8×8 block is effectively a 64-point discrete signal which is a function of the two spatial dimensions x and y. This signal is input into the DCT (step 102), which decomposes the 64 unique two-dimensional “spatial frequencies” which comprise the input signal's “spectrum.” The DCT outputs a set of 64 basis-signal amplitudes (DCT coefficients) (step 103). The DCT coefficients are divided into a “DC coefficient” (step 104) and “AC coefficients” (step 105). The DC coefficient is the coefficient with zero frequency in both dimensions, and the AC coefficients are the remaining 63 coefficients with non-zero frequencies. The DCT can concentrate most of the signal in the lower spatial frequencies. This means that most of the spatial frequencies have zero or near-zero amplitude and need not be encoded.

For purposes of compression, each of the 64 DCT coefficients may be uniformly quantized in conjunction with a 64-element quantization table (step 106), which is specified by the particular application. The quantization is intended to discard information that is not visually significant.

As is well known in the art, one type of compression commonly used is run length encoding (RLE) (step 107). RLE typically includes searching for repeated runs of a single symbol in an input stream, and replacing them by a single instance of the symbol and a run count. For example, if 100 values of zero are to be transmitted, then RLE writes ‘100×0’, which of course is more efficient than writing ‘0’ one hundred times. Accordingly, DCT-based coding schemes quantize the transformed image values so that most of the AC values are zero, and then using run-length coding to compress the data.

Because serial processors typically decode each transformed block separately, the data for each 8×8 or 16×16 block is transmitted as a unit (step 108). In a typical 8×8 block the DC value (at coordinates 0,0 of the 8×8 block) has a non-zero value, followed by 63 AC values, where some of these have non-zero values and most (typically) are zero. The likelihood of zero values increases as the AC coordinates move farther away from the DC (coordinate 8,8 has the highest incidence of zero, often because it is quantized the most severely). For example, a CIF (Common Intermediate Format) image (352×288 pixels) would be transmitted as a series of 1584 blocks of 8×8 DCT coefficients.

### SUMMARY OF THE INVENTION

The present invention seeks to provide methods for encoding DCT coordinates, as is described more in detail hereinbelow. In some embodiments of the invention, the encoding is particularly efficient when used with associative processing.

There is thus provided in accordance with an embodiment of the present invention a method for encoding DCT coordinates, the method including partitioning an image into blocks of size n×m, transforming the blocks with a DCT to obtain DCT coefficients, quantizing the DCT coefficients, and transmitting the DCT coefficients of the image as a series of (nm) streams, wherein each stream contains all of values representing a given coordinate within each of the blocks.

The method may include transmitting together all DC values from the entire image, which may be followed by transmitting all AC values in the image located at block coordinates (0,1−m), followed by transmitting all AC values in the image located at block coordinates (1−n,0). (This AC values may be transmitted after the DC values.) In accordance with an embodiment of the invention, transmitting the AC values may include run-length encoding run-lengths of zeros.

Further accordance with an embodiment of the invention, transmitting the streams may be carried out by means of associative processing. For example, this may include reading blocks of data sequentially from the stream and distributing the blocks of data throughout an associative processing array (APA).

In accordance with another embodiment of the invention, transmitting the AC values may include variable-length coding the DCT coefficients. In such a case, variable-length coding the DCT coefficients may include statistically determining different values that are most likely to occur at each coordinate of the blocks, and creating a variable-length coding table suited for each of the coordinates.

### BRIEF DESCRIPTION OF THE DRAWINGS

The present invention will be understood and appreciated more fully from the following detailed description, taken in conjunction with the drawings in which:

FIG. 1 is a simplified flow chart of a method for encoding DCT coordinates in the prior art; and

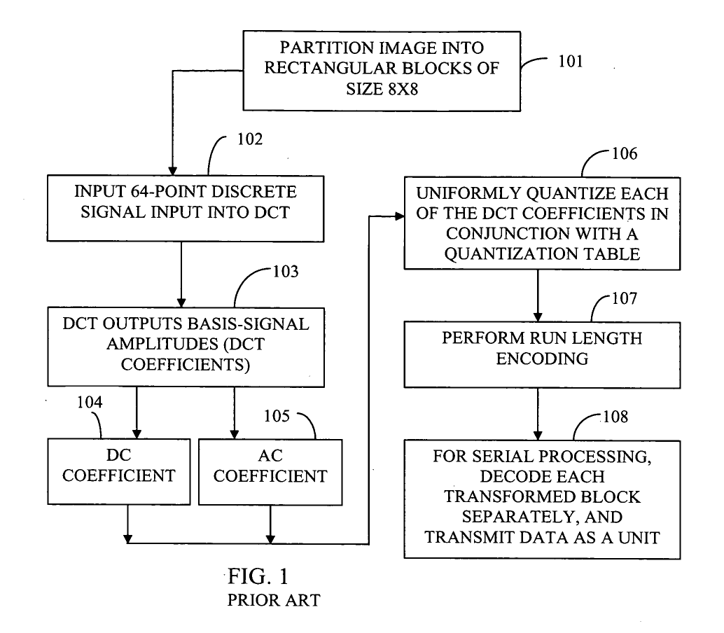

FIG. 2 is a simplified flow chart of a method for encoding DCT coordinates, in accordance with an embodiment of the present invention.

### DETAILED DESCRIPTION OF EMBODIMENTS

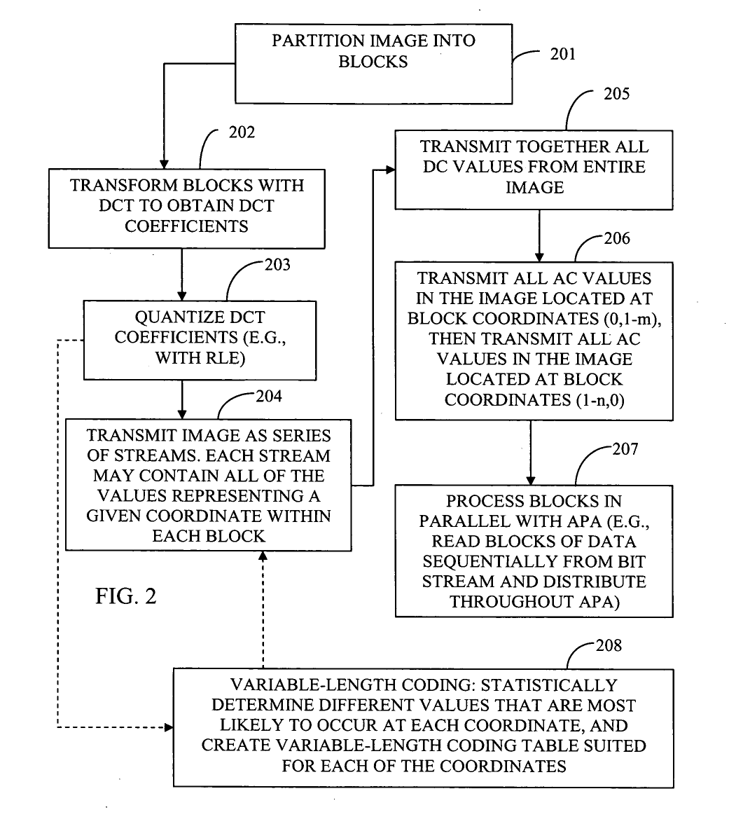

Reference is now made to FIG. 2, which is a flow chart of a method for encoding DCT coordinates, in accordance with an embodiment of the present invention.

As mentioned before, an image may be partitioned into blocks (such as but not limited to, 8×8 blocks) (step 201). Each block may be transformed with a DCT to obtain DCT coefficients (step 202). The DCT coefficients may be quantized (step 203).

As mentioned in the background, in the prior art, serial processors typically decode each transformed block of the image separately, and transmit the data for each block as a unit. In contrast in the present invention, the image may be transmitted as a series of streams (e.g., 64 streams for 8×8 blocks) (step 204). Each stream may contain all of the values representing a given coordinate within each block (e.g., 8×8 blocks).

In accordance with an embodiment of the present invention, all DC values from the entire image may be transmitted together (step 205), followed by all AC values in the image located at block coordinates (0,1), followed by all AC values in the image at block coordinates (0,2), etc. through all AC values in the image at block coordinates (8,8) (step 206). (In other words, transmitting all AC values in the image located at block coordinates (0,1−m), followed by transmitting all AC values in the image located at block coordinates (1−n,0).)

In the prior art, one can expect a maximum of 63 zeros in a run-length of zeros. In the present invention, one can expect a maximum of many more zeros. For example, in the CIF (352×288) image, there are 1584 values for each coordinate in all of the 8×8 blocks in the image. In most images, the values at coordinates (8,8) would be a series of 1584 zeros. There is a high probability that many of the preceding coordinates would also contain all (or many) zeros. In the present invention, one can run-length encode these coordinates by writing ‘1584×0’ or even combine run-lengths of zeros through coordinates and have ‘10,000×0’ or similar numbers. Coding efficiency may thus be enhanced by several orders of magnitude over the prior art.

The above-described method may be time-consuming with serial decoding processors, which would have to fetch data from disparate, non-consecutive addresses to build a single 8×8 block. However, the method may be very efficient for an associative processor that processes many blocks in parallel. Large blocks of data can be read sequentially from the bit stream and distributed throughout the associative processing array (APA) (step 207). For example, for an array of 16,384 processors, capable of processing 1024 blocks of 8×8 pixels in parallel, one may read 1024 DC values entering a single value at every 64^{th} APA word, then read 1024 AC values (coordinate (1,0)) and enter each directly below its respective DC value. In this way, the APA would be traversed 64 times, each time beginning at a subsequent index in the APA and entering each value at intervals of 64 APA words. Associative processing techniques with FIFO mechanisms for input/output that support such processing are readily available and are described, inter alia, in U.S. Pat. No. 6,460,127 to Akerib, the disclosure of which is incorporated herein by reference.

The present invention is not limited to RLE, and may be applied to variable-length coding as well. In such an embodiment, different values may be statistically determined that are most likely to occur at each coordinate, and a variable-length coding table may be created that is suited for each of the 64 coordinates (step 208). For example, it may be found that at coordinate (1,1), values in the range of 10-50 are more likely than values of 1-10, but at coordinate (5,5) the opposite may be true. Accordingly, a table may be created for coordinate (1,1) wherein values 10-50 are represented using fewer bits than values 1-10; whereas for coordinate (5,5) a second variable length table may be created wherein values 1-10 are represented using fewer bits than values 10-50.

It will be appreciated by persons skilled in the art that the present invention is not limited by what has been particularly shown and described hereinabove. Rather the scope of the present invention includes both combinations and subcombinations of the features described hereinabove as well as modifications and variations thereof which would occur to a person of skill in the art upon reading the foregoing description and which are not in the prior art.

What is claimed is:

1. A method for encoding DCT (Discrete Cosine Transform) coordinates, the method comprising:
partitioning an image into blocks of size n×m;
transforming said blocks with a DCT to obtain DCT coefficients;
quantizing said DCT coefficients; and
transmitting said DCT coefficients of the image as a series of (nm) streams, wherein each stream contains all of values representing a given coordinate within each of said blocks.

2. The method according to claim 1, comprising transmitting together all DC values from the entire image.

3. The method according to claim 2, further comprising transmitting all AC values in the image located at block coordinates (0,1−m), followed by transmitting all AC values in the image located at block coordinates (1−n,0).

4. The method according to claim 3, wherein transmitting the AC values is done after transmitting the DC values.

5. The method according to claim 3, wherein transmitting the AC values comprises run-length encoding run-lengths of zeros.

6. The method according to claim 1, comprising transmitting said streams by means of associative processing.

7. The method according to claim 6, comprising reading blocks of data sequentially from the stream and distributing the blocks of data throughout an associative processing array (APA).

8. The method according to claim 3, wherein transmitting the AC values comprises variable-length coding said DCT coefficients.

9. The method according to claim 8, wherein variable-length coding said DCT coefficients comprises statistically determining different values that are most likely to occur at each coordinate of the blocks, and creating a variable-length coding table suited for each of the coordinates.
